(19) United States
(12) Patent Application Publication
(10) Pub. No.: US 2025/0190813 A1
(43) Pub. Date: Jun. 12, 2025

(54) FINE-TUNING OF NEURAL NETWORKS

(71) Applicants: ADVANCED MICRO DEVICES, INC., Santa Clara, CA (US); XILINX, INC. (Longmont), Longmont, CO (US); XILINX, INC., San Jose, CO (US)

(72) Inventors: Adam H. Li, Solana Beach, CA (US); Alireza Khodamoradi, Longmont, CO (US); Benjamin T. Sander, Austin, TX (US); Eric Ford Dellinger, Longmont, CO (US); Kristof Denolf, Longmont, CO (US); Philip B. James-Roxby, Longmont, CO (US); Ralph Wittig, San Jose, CA (US)

(21) Appl. No.: 18/535,491

(22) Filed: Dec. 11, 2023

(51) Int. Cl. G06N 3/098

(52) U.S. Cl. CPC G06N 3/098

(57) ABSTRACT

Techniques are described for fine-tuning a neural network. A plurality of fine-tuning layers of a neural network are executed, each corresponding to a respective reference layer of a reference neural network. For each of the fine-tuning layers, a fine-tuning weight matrix is generated based on a reference weight matrix associated with the corresponding reference layer. One or more weights of the fine-tuning weight matrix are then iteratively adjusted based on a comparison of the output of the fine-tuning layer with the output of the corresponding reference layer.

### BACKGROUND

In the realm of Artificial Intelligence (AI) and Machine Learning (ML), a “model” refers to a mathematical representation of a real-world process. To create this model, a neural network implementing an algorithm is trained with input data, enabling the neural network to learn patterns or characteristics within the data. This learning phase results in the formation of parameters (weights and biases) within the model that constitute the model's knowledge. A trained model can then be used to make predictions or decisions without being explicitly programmed to perform the task. Such models can be executed by various types of neural networks (such as convolutional neural networks (CNNs) for image recognition, recurrent neural networks (RNNs) for sequential data, decision trees, support vector machines (SVMs), etc.).

Traditionally, ML and AI models undergo two general stages during development: training and fine-tuning. During the training stage, the model is developed through exposure to large quantities of training data. Following this, the model is optimized for inference in order to improve performance during actual use of the model, a process commonly termed deployment. Fine-tuning is an additional training phase designed to restore model accuracy, which typically falls (relative to its original trained state) due to side effects of the inference-optimizing process. Depending on the processes used, fine-tuning can demand considerable time and resources, often necessitating a re-execution of the entire training process.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates quantization and sparsity in the context of AI model training, such as are used to effectuate an adjustment of one or more weight values within an AI model's weight matrix.

FIG. 2 illustrates the impact of quantization and sparsity on the accuracy of an AI model, such as occurs when adjusting weights of an original weight matrix.

FIG. 3 illustrates an end-to-end training process in which a dataset of input images is used to train a neural network executing an AI model to identify the subject of those input images.

FIGS. 4-6 illustrate per-layer fine-tuning of an AI model, in accordance with some embodiments.

FIG. 7 illustrates a subset of processor-executable instructions for per-layer fine-tuning of a neural network, in accordance with some embodiments.

FIG. 8 illustrates an operational flow routine for fine-tuning a neural network in accordance with some embodiments.

FIG. 9 is a block diagram of a processing system designed to implement and fine-tune a neural network in accordance with one or more embodiments.

### DETAILED DESCRIPTION

As noted above, AI model training results in the generation of parameters (weights and biases) within the AI model that constitute that model's knowledge. Once trained, the model can then be executed by various types of neural networks (e.g., convolutional neural networks (CNNs), recurrent neural networks (RNNs), decision trees, support vector machines (SVMs), etc.).

To increase deployment efficiency and reduce operational costs, trained models often undergo a process of quantization and/or sparsification. Quantization allows model inference to be performed using lower precision datatypes, while sparsification allows model inference to be executed using a sparse replica of weight and/or activations.

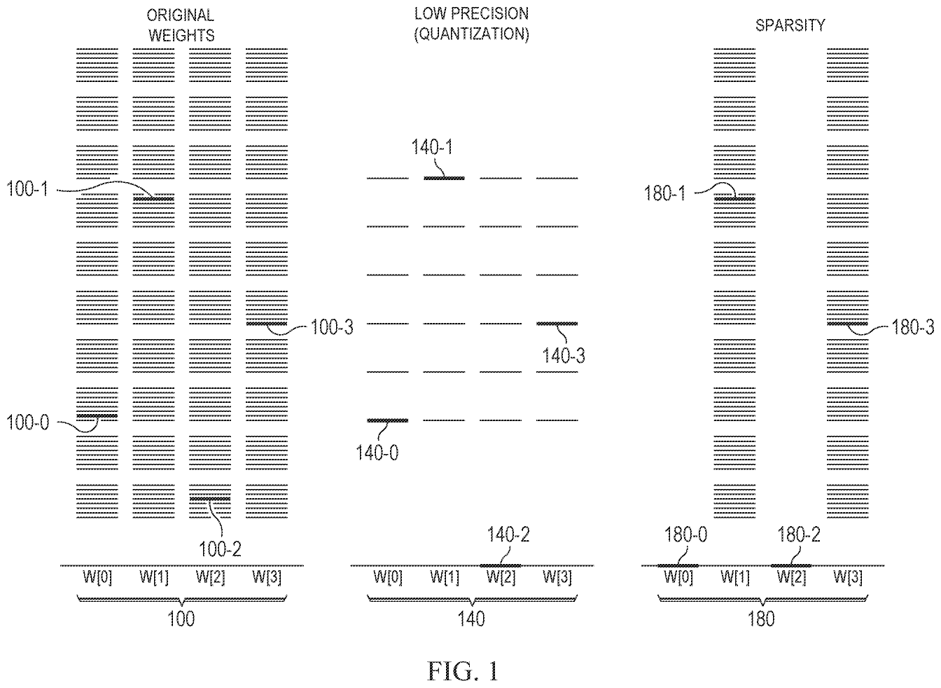

FIG. 1 illustrates quantization and sparsity in the context of AI model training, such as are used to effectuate an adjustment of one or more weight values within an AI model's weight matrix. As used herein, an output weight matrix is a data structure that stores the values of the weights or parameters connecting one layer of a neural network to the next layer. In various embodiments, a weight matrix is utilized to capture the contribution of each element (neuron) of a layer to those of the subsequent layer. The values in the output weight matrix are adjusted during the training process to optimize the neural network's performance, with the fine-tuned values representing the ‘knowledge’ the network has learned from the training data.

FIG. 1 includes an original weight matrix 100, which in this example is a potential weight matrix constituted by four distinct vectors (also termed tensors) of potential weights (labeled W[0], W[1], W[2], and W[3], respectively). In various scenarios and embodiments, each of these vectors represents a single layer of weights in a neural network, such that each vector corresponds to the weights from one neuron to the next layer of neurons. In certain scenarios, such vectors represent one slice of a multi-dimensional weight tensor in a more complex network architecture. Each of these vectors comprises a quantity of potential weights, within which is a single weight (respectively referenced as weights 100-0, 100-1, 100-2, 100-3).

FIG. 1 further includes a quantized weight matrix 140 that is a quantized version of the original weight matrix 100. As used herein, a quantized weight is a weight that has been transformed from a continuous or high-precision floating-point representation into a lower-precision and discrete representation, often as part of a quantization process designed to reduce computational requirements and/or memory usage. Thus, quantized weight matrix 140 comprises quantized versions of the weights of original weight matrix 100, such that each vector W[0], W[1], W[2], and W[3] now only accommodates weights within a particular set of discrete values. Weights 100-0, 100-1, 100-2, 100-3 from the original weight matrix 100 have been adjusted accordingly, and are now respectively represented as weight 140-0, 140-1, 140-2, 140-3. While the original weights 100-0, 100-1, 100-3 have undergone minor adjustment, weight 100-2 has been quantized such that quantized weight 140-2 has been assigned a value below the lowest of the accommodated quantized values, effectively removing it from the quantized weight matrix 140.

FIG. 1 further includes sparse weight matrix 180, in which the original weight matrix has been reduced via sparsity such that half of the weights from original weight matrix 100 are omitted from the sparse weight matrix 180. Accordingly, data from weight vectors W[1] and W[3] are preserved, such that corresponding highlighted weights 180-1 and 180-3 are identical to their counterparts 100-1 and 100-3 from the original weight matrix 100. However, data from weight vectors W[0] and W[2] are now excluded, resulting in weights 180-0 and 180-2 being effectively removed from the sparse weight matrix 180.

FIG. 1 thus provides a visual representation of quantization and sparsity involved in AI model training, illustrating the transformation of an original weight matrix through each of these stages. In various scenarios and embodiments, one or both of these quantization and sparsity processes may be employed to reduce a size of the corresponding model's weight matrix. However, while these processes may typically reduce deployment costs, they often lead to a significant drop in model accuracy.

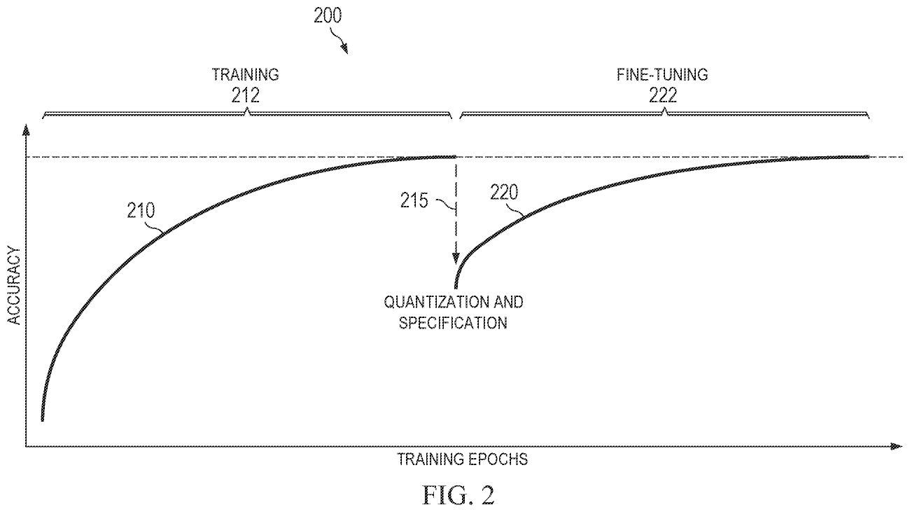

FIG. 2 illustrates the impact of quantization and sparsity on the accuracy of an AI model, such as occurs when adjusting weights of an original weight matrix (e.g., original weight matrix 100 of FIG. 1). In particular, FIG. 2 depicts an accuracy graph 200 illustrating the evolution of model accuracy throughout different phases of an AI model's development cycle: initial training, quantization and sparsification, and fine-tuning. The x-axis of the graph 200 corresponds to a quantity of training epochs, essentially indicating the amount of computational resources expended on the training and fine-tuning phases. The y-axis represents the accuracy of the model.

In the context of neural network training, a single training epoch refers to one complete pass through a training data set. During a training epoch, the neural network's weights and biases are updated in an attempt to minimize the output error in relation to the training examples. In certain scenarios and embodiments, the process of forward propagation (calculating predicted outputs) and backpropagation (updating the weights and biases) is performed for every example in the training data set. Typically, after each training epoch, the error rate for the training set is calculated. This error rate is often used as a metric to monitor learning progress of the neural network and its model. In certain embodiments, calculating the error rate may include calculating a loss value, which is a quantified measure of discrepancies between the predictions made by an AI model or a neural network and actual or true data. In the context of training or fine-tuning a neural network, it is generally advantageous to minimize this loss value, thereby improving the performance and accuracy of the neural network.

The accuracy graph 200 begins with a southwest-to-northeast curve, referenced herein as training curve 210. This curve indicates the model's accuracy throughout the initial training phase, gradually increasing as more training epochs are expended.

Once the model achieves a satisfactory level of accuracy, the original weight matrix is quantized and/or sparsified in a manner similar to that described above respect to FIG. 1, such that portions of the weight matrix are excluded and the values within the weight matrix are adjusted to a lower degree of precision. The effects of quantization and sparsification are represented by the vertical arrow 215, indicating a resulting immediate decrease in model accuracy. However, the reduction in model size due to quantization and sparsification makes the model more computationally efficient. This leaner model offers significant advantages in deployment scenarios, especially those that demand quick responses to a multitude of simultaneous requests.

In response to the decrease in accuracy, the model then enters a fine-tuning phase 222. This stage is depicted by the fine-tuning curve 220 on the right side of the graph, in which additional training epochs are utilized to increase the model's accuracy back to a level comparable to that of the initially trained model despite the reduced model size resulting from quantization and sparsification.

As generally indicated by the respective training period 212 and fine-tuning period 222, the span of training epochs occupied by the fine-tuning curve 220 is typically substantially similar to that of the initial training curve 210, indicating that the training epochs required for fine-tuning the model are approximately equivalent to those utilized during its initial training.

Embodiments of techniques described herein provide expedited and efficient fine-tuning for models subsequent to quantization and/or sparsification, enabling such fine-tuning to be performed faster (potentially hundreds to thousands of times faster) than prior approaches. Unlike those prior approaches, embodiments of these techniques leverage an already-trained model as a reference point for fine-tuning a corresponding quantized/sparsified model beyond its initial starting point. In particular, output from each of the sublayers in the fine-tuning process is utilized on a per-layer basis to adjust weights of the quantized/sparsified model. In this manner, the output of each layer is aligned with the corresponding output from the same layers in the reference model.

In certain scenarios and embodiments, the described fine-tuning techniques provide significant advantages in terms of computational efficiency, as well as accuracy of the resulting fine-tuned AI models. As one example, prior approaches to the training and fine-tuning of an AI model (e.g., using ResNet18) have taken up to 8.5 hours on eight exemplary graphics processing units (GPUs). In contrast, approaches described herein have been tested as completing the process in approximately 6 minutes on a single such exemplary GPU, yielding a speed increase of approximately 700×.

The described techniques also maintain a high level of accuracy, achieving results close to the performance of the reference model. In one example, a 2:4 sparse model (indicating a model in which half of the output weights are permitted via sparsity) fine-tuned in accordance with techniques described herein achieved an accuracy of 66.67±0.05%, which is 97.00±0.08% of the reference ResNet18 model accuracy of 69.760%. Additional epochs of retraining can further enhance this accuracy, with an addition of 10 training epochs improving performance to 99.8% of the reference model's accuracy.

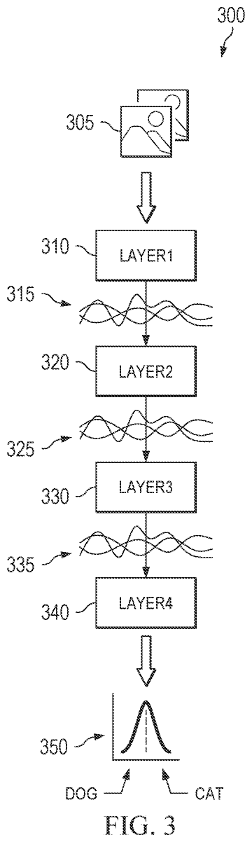

FIG. 3 illustrates an end-to-end training process for a neural network 300, in which a dataset of the input image is 305 is used to train an AI model that, in the depicted example, includes four successive layers 310, 320, 330, 340.

The input image dataset 305, which in the depicted scenario includes a multitude of images that are each labeled as being of either a cat or a dog, is utilized to train an AI model. In the depicted scenario, the neural network 300 is structured as a multi-layered neural network consisting of successive layers 310, 320, 330, and 340. Each layer processes its input data and provides output to the next. In particular, layer 310 provides its output as input to layer 320; layer 320 provides its output as input to layer 330; and layer 330 provides its output as input to layer 340.

In the depicted scenario, positioned between each pair of successive layers 310, 320, 330, 340 are unique weight matrices 315, 325, and 335. These weight matrices, which form as a result of the respective preceding layer's output, are continuously adjusted during the training process to reduce prediction errors, thereby improving the AI model's overall accuracy.

The first layer, layer 310, is designed to receive and process the input image from dataset 305. The output of this layer is modulated by the weight matrix 315, which is an output weight matrix for layer 310. The modified output is then fed as input into the succeeding layer 320. Similarly, the second layer 320 processes its input and generates an output, which is subsequently modulated by weight matrix 325. This modulated output is then passed on to layer 330. Layer 330, after processing its input, also generates an output, which is modulated by weight matrix 335 before being input into the final layer, layer 340.

Each of the weight matrices 315, 325, 335 is distinct and may contain different values, depending on the features each layer is intended to learn and the errors propagated back during the training process. The values within these matrices are continuously updated during the training process to gradually improve the model's ability to differentiate between ‘cat’ and ‘dog’ images.

The final layer 340 receives its input from layer 330, as modulated via weight matrix 335. It uses this processed input to make a final prediction as to whether the input image from dataset 305 is of a ‘cat’ or a ‘dog’. The output of this layer constitutes the final output of the AI model and culminates in identification results 350, which indicates the model's respective decisions regarding the identification of each input image in the training dataset 305.

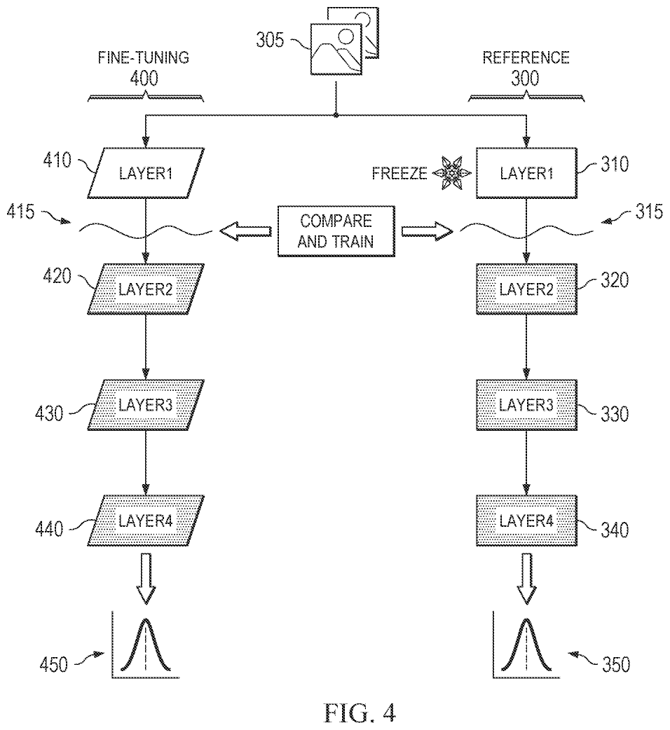

FIG. 4 illustrates per-layer fine-tuning of a neural network 400 in accordance with some embodiments. In the depicted embodiment, the neural network 300 from FIG. 3 is utilized as a reference neural network, as depicted in the top half of the illustration, having been trained by the dataset 305 as processed through successive reference layers 310, 320, 330, and 340 to provide identification results 350. The fine-tuning neural network 400 includes fine-tuning layers 410, 420, 430, and 440, all of which combine to provide identification results 450. Fine-tuning neural network 400 is utilized to improve the accuracy of its AI model, which is a quantized and/or sparsified version of the AI model executed by the reference neural network 300.

In the illustrated per-layer approach to fine-tuning, a comparison and iterative adjustment process is performed between the output weight matrices from corresponding layers of the reference neural network 300 and fine-tuning neural network 400, such as in order to adjust individual weights of a quantized and specified weight matrix in the fine-tuning neural network 400 to substantially match a corresponding output weight matrix of the reference neural network 300. In the depicted embodiment, for example, weights of the output weight matrix 415 are adjusted during the fine-tuning process in order to substantially match those of the reference output weight matrix 315.

In FIG. 4, reference layer 310 from the reference neural network 300 is frozen, indicating that during the fine-tuning process, all parameters of reference layers 310 (including the values of individual weights within weight matrix 315) are kept constant. This frozen state serves as reference for the corresponding layer in the fine-tuning neural network 400 being fine-tuned.

Meanwhile, fine-tuning layer 410 undergoes the fine-tuning process in order to adjust the weights in its weight matrix 415 such that the output of the layer 410 is as similar as possible to the output of reference layer 310. This process leverages the concept of knowledge distillation, where knowledge, in the form of learned features and representations, is effectively transferred from the reference layer 310 to the fine-tuning layer 410.

In certain embodiments, the comparison and training process involves forward propagation of input data from image dataset 305 through both reference layer 310 and fine-tuning layer 410, and a subsequent comparison of the resultant output weight matrices 315 and 415. The difference between these two outputs is calculated, typically in the form of a loss or error measure. The weights of output weight matrix 415 are then iteratively adjusted via backpropagation in an attempt to minimize this difference, effectively training fine-tuning layer 410 to mimic the behavior and knowledge of reference layer 310.

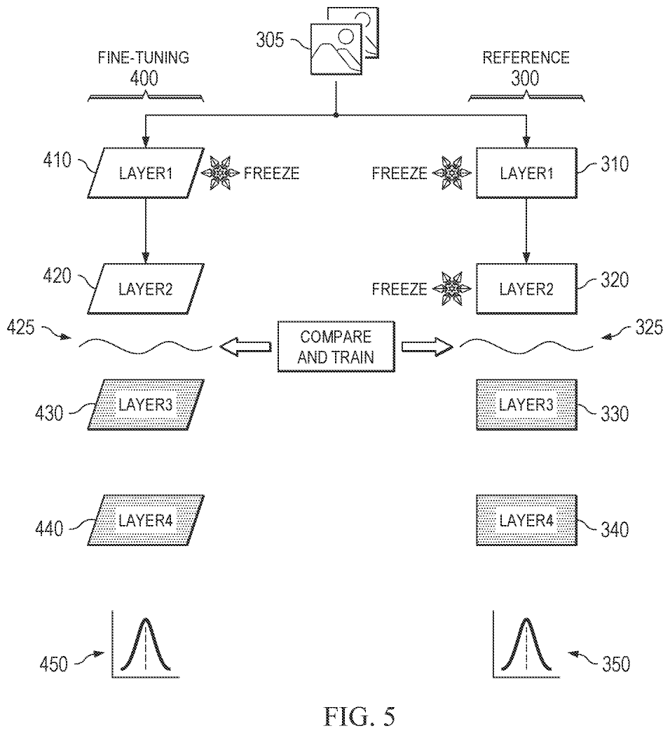

FIG. 5 continues the example of fine-tuning the neural network 400 of FIG. 4 in accordance with some embodiments. In this subsequent stage of the fine-tuning process, the reference layers 310 and 320 are now frozen, indicating that their parameters (including the values in their respective output weight matrices 315 and 325) are kept constant. Fine-tuning layer 410 is now also frozen, such that its parameters (including the now-adjusted weights in output weight matrix 415, not shown) are held constant following the fine-tuning adjustments made in the previous stage discussed above with respect to FIG. 4.

In this stage, the comparison and training process shifts to compare the output weight matrices of the second layer in each network. Specifically, the output weight matrix 325 from reference layer 320 of the reference neural network and output weight matrix 425 from fine-tuning layer 420 are now compared, with weights in the output weight matrix 425 iteratively adjusted such that the output from fine-tuning layer 420 is matched as closely as possible to the output from reference layer 320.

Similar to the process detailed in the description of FIG. 4, in various embodiments comparison and training of the output weight matrices 325, 425 involves forward propagation of the input data from the image dataset 305 through both layers 320 and 420, and a subsequent comparison of the resultant output weight matrices 325 and 425. The difference between these two outputs is then calculated, typically using a loss or error measure. Subsequently, the weights of output weight matrix 425 are adjusted (such as via backpropagation) in an effort to minimize such differences, effectively training fine-tuning layer 420 to mimic the behavior and knowledge of reference layer 320.

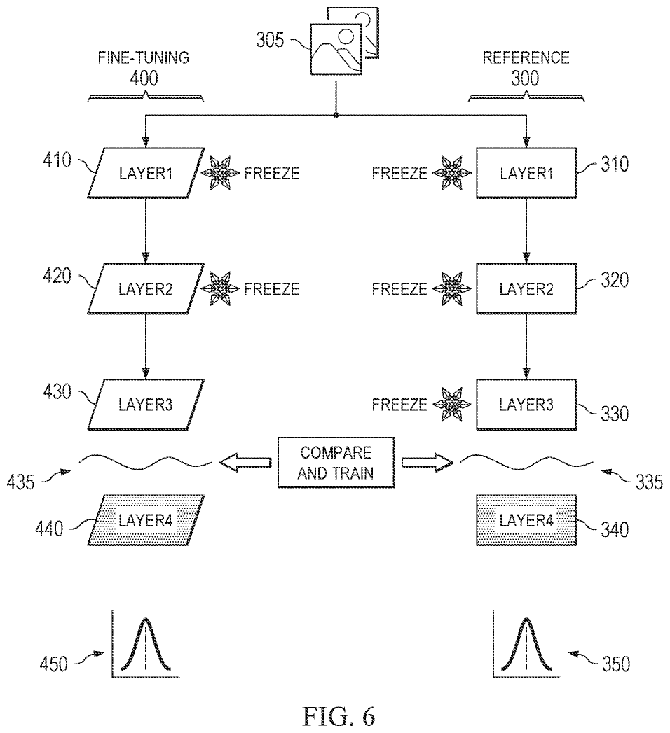

FIG. 6 continues the example of fine-tuning the neural network of FIGS. 4 and 5 in accordance with some embodiments. In this subsequent stage of the fine-tuning process, the reference layers 310, 320 and 330 are frozen, indicating that their parameters (including the values in their respective output weight matrices 315, 325, 335) are kept constant. Fine-tuning layers 410 and 420 are also frozen, such that their respective parameters (including the now-adjusted weights in output weight matrix 425, not shown) are held constant following the fine-tuning adjustments made in the previous stages discussed above with respect to FIGS. 4 and 5.

In this stage, the comparison and training process shifts to compare the output weight matrices of the third layer in each network. Specifically, the output weight matrix 335 from reference layer 330 of the reference neural network and output weight matrix 435 from fine-tuning layer 430 are now compared, with weights in the output weight matrix 435 iteratively adjusted such that the output from fine-tuning layer 430 is matched as closely as possible to the output from reference layer 330.

Similar to the process detailed in the description of FIG. 4, in various embodiments comparison and training of the output weight matrices 335, 435 involves forward propagation of the input data from the image dataset 305 through both reference layer 330 and fine-tuning layer 430, and a subsequent comparison of the resultant output weight matrices 335 and 435. The difference between these two outputs is then calculated, and weights of output weight matrix 435 adjusted (such as via backpropagation) to minimize such differences, effectively training fine-tuning layer 430 to mimic the behavior and knowledge of reference layer 330.

Thus, each stage in the depicted fine-tuning process moves layer by layer through the fine-tuning neural network to adjust and optimize each corresponding layer individually based on its corresponding layer from the reference neural network. In various embodiments, such granularity provides enhanced control over the fine-tuning process, potentially improving the effectiveness of the fine-tuned model by ensuring that each layer accurately reflects the knowledge of its counterpart layer in the reference neural network.

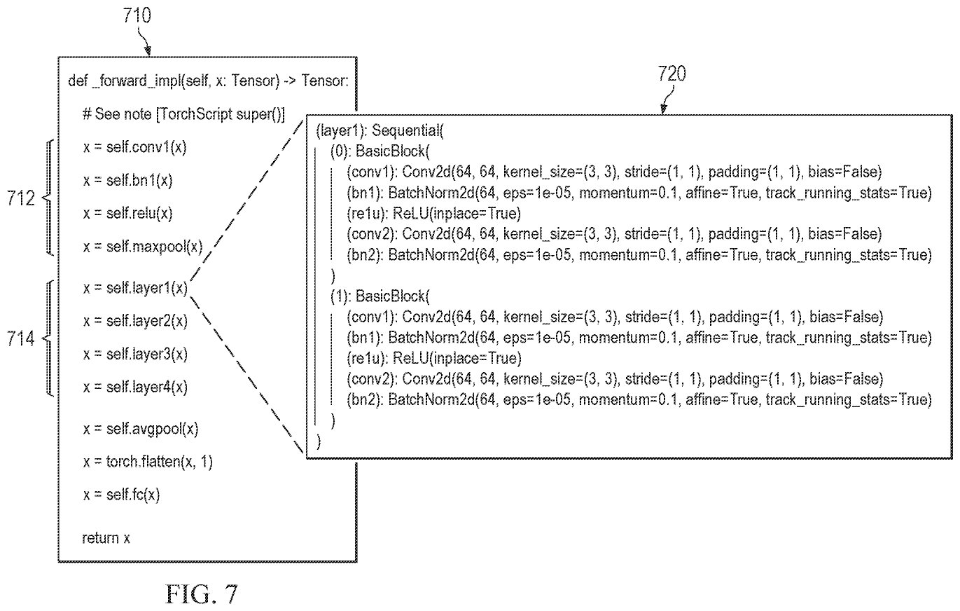

FIG. 7 illustrates a subset of processor-executable instructions for per-layer fine-tuning of a neural network, in accordance with some embodiments. FIG. 7 depicts two distinct code segments 710 and 720, which in the depicted example are written in the Python programming language for implementing and fine-tuning a neural network AI model in accordance with various embodiments.

Code segment 710 illustrates an implementation of a forward pass function (‘_forward_impl’) as used for training and fine-tuning the AI model. In the depicted embodiment, the forward pass function accepts an input tensor ‘x’ and performs a series of operations 712 using various layers of the neural network AI model. In particular, the input tensor is processed through convolutional (‘conv1’), batch normalization (‘bn1’), ReLU activation (‘relu’), and max pooling (‘maxpool’) layers. In operations 714, the processed tensor is then passed sequentially through multiple layers, respectively referenced within code segment 710 as ‘layer1’, ‘layer2’, ‘layer3’, and ‘layer4’.

Each of these layers represents a higher-level module comprising multiple operations and sub-layers, as exemplified by the expansion of ‘layer1’ in code segment 720. In the depicted embodiment and as illustrated via code segment 720, ‘layer1’ comprises two instances of a ‘BasicBlock’ class. As shown, each ‘BasicBlock’ represents a segment of the neural network, including two convolutional layers (‘conv1’ and ‘conv2’), two batch normalization layers (‘bn1’ and ‘bn2’), and a ReLU activation layer (‘relu’).

In operation, a fine-tuning process such as that illustrated in FIGS. 4-6 would execute multiple instances of the code segment 710 (and 720), such as one instance of code segment 710 to implement the reference neural network 300 and another instance to implement the fine-tuning neural network 400, with multiple instances of each of ‘layer1’, ‘layer2’, ‘layer3’, and ‘layer4’ accordingly.

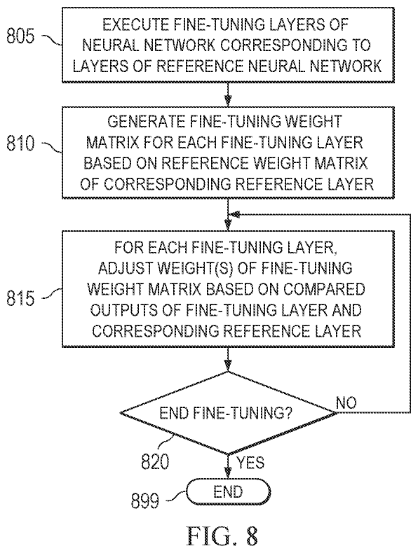

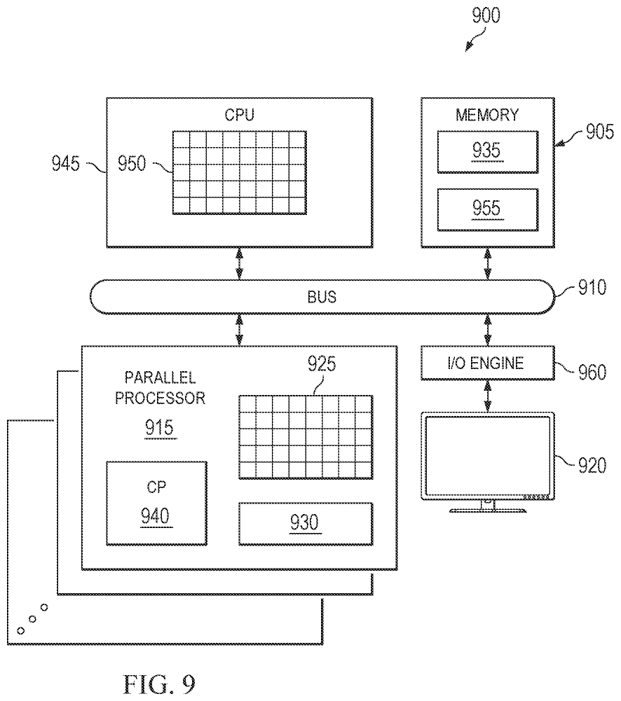

FIG. 8 illustrates an operational flow routine for fine-tuning a neural network in accordance with some embodiments. The operational flow routine may be performed, for example, by one or more processors (e.g., parallel processors 915 of FIG. 9, discussed below).

The routine begins at block 805, in which the fine-tuning layers of a neural network are executed. Each fine-tuning layer corresponds to a respective layer in a reference neural network, providing a standard of performance for comparison. The routine proceeds to block 810.

At block 810, a fine-tuning weight matrix is generated for each of the fine-tuning layers, using the reference weight matrix of the corresponding reference layer as a basis. This weight matrix will dictate the behavior and output of the fine-tuning layer. In various embodiments, the generation of the fine-tuning weight matrix may include applying one or more transformation processes to the reference weight matrix, such as a quantization process or sparsification process. The routine proceeds to block 815.

At block 815, an iterative adjustment process begins. For each fine-tuning layer, one or more weights in the fine-tuning weight matrix are adjusted based on a comparison between the output of the fine-tuning layer and that of its corresponding reference layer. By minimizing the difference between these two outputs, the performance of the fine-tuning layer can be optimized to match that of the reference layer as closely as possible.

At block 820, the routine determines whether to end the fine-tuning process. In various embodiments, this determination is based on one or more of various criteria, such as satisfying a pre-determined accuracy threshold, performing a specified number of iterations, satisfying a pre-determined quantity of training epochs, etc. For example, if the difference between the outputs of the fine-tuning layer and its corresponding reference layer falls below a certain threshold, it may indicate that the fine-tuning process has achieved a satisfactory level of accuracy and can be concluded. As another example, if a set number of iterations has been completed without reaching the desired level of accuracy, the routine may determine to end the fine-tuning process.

If at block 820 it is determined that the fine-tuning process has not satisfied the relevant ending criteria, the routine returns to block 815 to continue iteratively adjusting the weights in the fine-tuning weight matrix. Otherwise, the routine proceeds to block 899 and ends.

FIG. 9 is a block diagram of a processing system 900 designed to implement fine-tuning of a neural network in accordance with one or more embodiments. The processing system 900 is generally designed to execute sets of instructions or commands to carry out tasks on behalf of an electronic device, such as a desktop computer, laptop computer, server, smartphone, tablet, game console, and the like.

The processing system 900 includes or has access to a memory 905 or other storage component that is implemented using a non-transitory computer readable medium, such as dynamic random access memory (DRAM). The processing system 900 also includes a bus 910 to support communication between entities implemented in the processing system 900, such as the memory 905. In certain embodiments, the processing system 900 includes other buses, bridges, switches, routers, and the like, which are not shown in FIG. 9 in the interest of clarity.

The processing system 900 includes one or more parallel processors 915 that are configured to render images for presentation on a display 920. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 915 can render objects to produce pixel values that are provided to the display 920. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 915 is also used for general-purpose computing. For instance, the parallel processor 915 can be used to implement machine learning algorithms such as one or more implementations of a CNN as described herein. In some cases, operations of multiple parallel processors 915 are coordinated to execute a machine learning algorithm, such as if a single parallel processor 915 does not possess enough processing power to run the machine learning algorithm on its own.

The parallel processor 915 implements multiple processing elements (also referred to as compute units) 925 that are configured to execute instructions concurrently or in parallel. The parallel processor 915 also includes an internal (or on-chip) memory 930 that includes a local data store (LDS), as well as caches, registers, or buffers utilized by the compute units 925. The parallel processor 915 can execute instructions stored in the memory 905 and store information in the memory 905 such as the results of the executed instructions. The parallel processor 915 also includes a command processor 940 that receives task requests and dispatches tasks to one or more of the compute units 925.

The processing system 900 also includes a central processing unit (CPU) 945 that is connected to the bus 910 and communicates with the parallel processor 915 and the memory 905 via the bus 910. The CPU 945 implements multiple processing elements (also referred to as processor cores) 950 that are configured to execute instructions concurrently or in parallel. The CPU 945 can execute instructions such as program code 955 stored in the memory 905 and the CPU 945 can store information in the memory 905 such as the results of the executed instructions.

An input/output (I/O) engine 960 handles input or output operations associated with the display 920, as well as other elements of the processing system 900 such as keyboards, mice, printers, external disks, and the like. The I/O engine 960 is coupled to the bus 910 so that the I/O engine 960 communicates with the memory 905, the parallel processor 915, or the CPU 945.

In operation, the CPU 945 issues commands to the parallel processor 915 to initiate processing of a kernel that represents the program instructions that are executed by the parallel processor 915. Multiple instances of the kernel, referred to herein as threads or work items, are executed concurrently or in parallel using subsets of the compute units 925. In some embodiments, the threads execute according to single-instruction-multiple-data (SIMD) protocols so that each thread executes the same instruction on different data. The threads are collected into workgroups (also termed thread groups) that are executed on different compute units 925. For example, the command processor 940 can receive these commands and schedule tasks for execution on the compute units 925.

In some embodiments, the parallel processor 915 implements a graphics pipeline that includes multiple stages configured for concurrent processing of different primitives in response to a draw call. Stages of the graphics pipeline in the parallel processor 915 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

As used herein, a layer in a neural network is a hardware-or software-implemented construct in a processing system, such as processing system 900. In various embodiments, such a layer may perform one or more operations via processing circuitry of the processing system 900 to serve as a collection or group of interconnected neurons or nodes, arranged in a structure that can be optimized for execution on one or more parallel processors (e.g., parallel processors 915) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data—for example, raw data input into an input layer or the transformed data passed between hidden layers. This transformation process involves the use of an output weight matrix, which is held in memory (e.g., memory 905) and manipulated by the central processing unit (CPU) 945 and/or the parallel processors 915.

In some instances, such layers may be distributed across multiple processing units within a system. For instance, different layers or groups of layers may be executed on different compute units 925 within a single parallel processor 915, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to optimize or otherwise improve’ performance of the neural network.

In some embodiments, the apparatus and techniques described above are implemented in a system including one or more integrated circuit (IC) devices (also referred to as integrated circuit packages or microchips), such as the neural network fine-tuning systems described above with reference to FIGS. 3-9. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for fine-tuning a neural network, comprising:
executing a plurality of fine-tuning layers of a neural network, each fine-tuning layer corresponding to a respective reference layer of a reference neural network, each reference layer associated with a respective reference weight matrix; and
for each fine-tuning layer of the plurality of fine-tuning layers:
generating a fine-tuning weight matrix based on the reference weight matrix associated with the corresponding reference layer; and
iteratively adjusting one or more weights of the fine-tuning weight matrix based on a comparison of output of the fine-tuning layer with output of the corresponding reference layer.

2. The method of claim 1, wherein iteratively adjusting the one or more weights of the fine-tuning weight matrix comprises iteratively adjusting the one or more weights while keeping constant the reference weight matrix of the associated reference layer.

3. The method of claim 2, wherein iteratively adjusting the one or more weights of the fine-tuning weight matrix comprises iteratively adjusting the one or more weights while keeping constant the reference weight matrices of one or more preceding reference layers of the reference neural network.

4. The method of claim 1, wherein iteratively adjusting the one or more weights of the fine-tuning weight matrix comprises:
comparing the fine-tuning weight matrix with the reference weight matrix associated with the corresponding reference layer;
determining an error rate based on the comparing; and
adjusting the one or more weights of the fine-tuning weight matrix based on the determined error rate.

5. The method of claim 1, further comprising training the reference neural network to generate the respective reference weight matrices.

6. The method of claim 1, wherein generating the fine-tuning weight matrix comprises applying a quantization process to the reference weight matrix associated with the corresponding reference layer.

7. The method of claim 1, wherein generating the fine-tuning weight matrix includes applying a sparsification process to the reference weight matrix associated with the corresponding reference layer.

8. A system, comprising:
a memory storing a plurality of fine-tuning layers of a neural network, wherein each fine-tuning layer corresponds to a respective reference layer of a reference neural network, and wherein each reference layer is associated with a respective reference weight matrix; and
one or more processors configured to, for each fine-tuning layer of the plurality of fine-tuning layers:
generate a fine-tuning weight matrix based on the reference weight matrix associated with the corresponding reference layer; and
iteratively adjust one or more weights of the fine-tuning weight matrix based on a comparison of output of the fine-tuning layer with output of the corresponding reference layer.

9. The system of claim 8, wherein the one or more processors are configured to iteratively adjust the one or more weights of the fine-tuning weight matrix while keeping constant the reference weight matrix of the associated reference layer.

10. The system of claim 9, wherein the one or more processors are configured to iteratively adjust the one or more weights of the fine-tuning weight matrix while keeping constant the reference weight matrices of one or more preceding reference layers of the reference neural network.

11. The system of claim 8, wherein the one or more processors are configured to iteratively adjust the one or more weights of the fine-tuning weight matrix by:
comparing the fine-tuning weight matrix with the reference weight matrix associated with the corresponding reference layer;
determining an error rate based on the comparing; and
adjusting the one or more weights of the fine-tuning weight matrix based on the determined error rate.

12. The system of claim 8, wherein the one or more processors are further configured to train the reference neural network to generate the respective reference weight matrices.

13. The system of claim 8, wherein the one or more processors are configured to generate the fine-tuning weight matrix by applying a quantization process to the reference weight matrix associated with the corresponding reference layer.

14. The system of claim 8, wherein the one or more processors are configured to generate the fine-tuning weight matrix by applying a sparsification process to the reference weight matrix associated with the corresponding reference layer.

15. A non-transitory computer-readable medium storing instructions that, when executed by one or more processors, configure the one or more processors to:
execute a plurality of fine-tuning layers of a neural network, each fine-tuning layer corresponding to a respective reference layer of a reference neural network, each reference layer associated with a respective reference weight matrix; and
for each fine-tuning layer of the plurality of fine-tuning layers:
generate a fine-tuning weight matrix based on the reference weight matrix associated with the corresponding reference layer; and
iteratively adjust one or more weights of the fine-tuning weight matrix based on a comparison of output of the fine-tuning layer with output of the corresponding reference layer.

16. The non-transitory computer-readable medium of claim 15, wherein the instructions further configure the one or more processors to iteratively adjust the one or more weights while keeping constant the reference weight matrix of the associated reference layer.

17. The non-transitory computer-readable medium of claim 16, wherein the instructions further configure the one or more processors to iteratively adjust the one or more weights while keeping constant the reference weight matrices of one or more preceding reference layers of the reference neural network.

18. The non-transitory computer-readable medium of claim 15, wherein the instructions configure the one or more processors to iteratively adjust the one or more weights of the fine-tuning weight matrix by:
comparing the fine-tuning weight matrix with the reference weight matrix associated with the corresponding reference layer;
determining an error rate based on the comparing; and
adjusting the one or more weights of the fine-tuning weight matrix based on the determined error rate.

19. The non-transitory computer-readable medium of claim 15, wherein the instructions further configure the one or more processors to train the reference neural network to generate the respective reference weight matrices.

20. The non-transitory computer-readable medium of claim 15, wherein to generate the fine-tuning weight matrix includes to apply a quantization process to the reference weight matrix associated with the corresponding reference layer.

21. The non-transitory computer-readable medium of claim 15, wherein to generate the fine-tuning weight matrix includes to apply a sparsification process to the reference weight matrix associated with the corresponding reference layer.
